(19) United States
(12) Patent Application Publication
(10) Pub. No.: US 2026/0112358 A1
(43) Pub. Date: Apr. 23, 2026

(54) TRANSFORMER MODEL TRAINING FOR SPEECH RECOGNITION

(71) Applicant: Useful Sensors Inc., Mountain View, CA (US)

(72) Inventor: Manjunath Kudlur, Saratoga, CA (US)

(73) Assignee: Useful Sensors Inc., Mountain View, CA (US)

(21) Appl. No.: 19/362,571

(22) Filed: Oct. 20, 2025

Related U.S. Application Data
(60) Provisional application No. 63/709,569, filed on Oct. 21, 2024.

(51) Int. Cl. G10L 15/16; G10L 15/04; G10L 15/06

(52) U.S. Cl. CPC G10L 15/16; G10L 15/04; G10L 15/063

(57) ABSTRACT

A plurality of speech segments of variable length are obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) are used at each of the convolutional layers of the model. A further speech segment is obtained and analyzed using the encoder-decoder transformer model which was trained. Speech recognition is performed on the further speech segment using the analysis performed by the encoder-decoder transformer model. The speech recognition is accomplished in real time. Audio features are generated, based on the plurality of speech segments.

### RELATED APPLICATIONS

This application claims the benefit of U.S. provisional patent application “Transformer Model Training For Speech Recognition” Ser. No. 63/709,569, filed October 21, 2024.

The foregoing application is hereby incorporated by reference in its entirety.

### FIELD OF ART

This application relates generally to audio analysis and more particularly to transformer model training for speech recognition.

### BACKGROUND

Education is a foundational process that shapes and molds human beings. It provides knowledge, skills, mores, and values for both personal and societal development. Education begins at birth and continues throughout our lives, at home, in schools, in the workplace, and alongside others through experiences and interactions. In today’s world, education is crucial for survival and success. It equips us with the ability to think critically, solve problems, and adapt to changing environments. It fosters innovation and drives economic growth by creating a skilled workforce capable of meeting the demands of various industries and social challenges. Education promotes unity by providing opportunity, regardless of background or preferences. It helps people understand their rights and responsibilities to one another and to society, encouraging participation in civic life and contributing to the development of a just and fair culture. Political organization and practice may differ from one nation to another, but every culture can benefit from an educated and diverse populace. Education is not simply about acquiring knowledge, but also about developing the ability to apply that knowledge in real-world situations. It is a lifelong journey that helps each person make meaningful contributions to their communities and the world at large.

Education necessarily involves data. And the amount of data that exists in the world today is quite astronomical. Imagine that every written and spoken word by billions of earth inhabitants is a datum. Putting all that data into a usable form was long considered impossible, with historical records only capturing an infinitesimal fraction of all the data. In addition, vast amounts of data exist from various other sources. For example, every xray, CT scan, ultrasound, and MRI requires millions of bytes of data for storage, processing, interpretation, and so on. At one point, it was estimated that medical imaging data represented an astounding half of all the extant data stored around the world. The list of various types of data seems to go on and on. A single movie can consist of gigabytes of data. Cars and smart vehicles can capture and process data continuously. Even refrigerators can collect, process, display, transmit, and store data! Data usage indeed seems to be only limited by one’s imagination.

With the advent of the Internet, access to data has been greatly enhanced. Videos can be streamed online and on demand over the Internet. Creators and influencers vie for followers by making their particular type of data valuable or desirable for others. Search engines enable users to find all sorts of interesting and intriguing bits of data located almost anywhere over the vast Internet. In addition, many business and government entities have their own private network or intranet, which can only be accessed with appropriate credentials, but which nonetheless present challenges to finding and accessing needed data. Even with improved access to data, the ability to classify, interpret, and use the data for productive purposes remains a difficult problem. For example, just because one can find data on the Internet, there is no guarantee that the data is actually valid data. In fact, there is perhaps as much news reporting today about disinformation as there is about information! Two things are clear from current data generation directions: the amount of data will continue to grow at an almost unfathomable rate, and the challenges related to finding, accessing, and productively using such data will likewise continue to grow.

### SUMMARY

Artificial intelligence and machine learning systems are designed to mimic human learning processes. Like people, machine learning (ML) systems are exposed to massive amounts of data. At first, the data can appear to be disorganized and even chaotic. But as the ML systems begin the process of analyzing the data, patterns begin to emerge. Like babies, the systems gradually learn to filter out less useful bits of information and pay attention to the pieces of data that forward understanding. Trial and error methods used by humans can be replicated in ML systems by applying various algorithms to sift and reorganize data in order to arrive at meaningful conclusions. Random noise becomes music or a spoken language. Lights, colors, and shapes reveal faces and objects. As patterns and best methods of organizing information are discovered, new data can be taken in and assessed more quickly. Like a child learning to read, vocabulary, syntax, grammar, and sentence complexity expand in machine learning systems that specialize in natural language processing (NLP). Datastores with millions of words spanning thousands of documents of various sizes and forms can be fed into ML systems, allowing for specialization in many different fields. Simply taking in more data, however, is not enough. The information must be processed more efficiently. Superfluous or unnecessary chatter surrounding useful pieces of data must be stripped away. In humans, the ability to focus attention on the most important pieces of information is learned through experience and discipline. All five senses become better aligned with the mind in order to channel the right data to the right places at the best time. In ML systems, data can be packed more closely together. Compression routines can pack the most essential data into fewer bits and bytes, without losing any important details. Filler characters can be discarded. As a result, language can be understood more quickly and responses produced at a more human-like pace. Chatbots and virtual humans can converse with humans in conversations that become increasingly natural as the systems evolve and mature.

Techniques for transformer model training for speech recognition are disclosed. A plurality of speech segments of variable length is obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) are used at each of the convolutional layers of the model. A further speech segment is obtained and analyzed using the encoder-decoder transformer model which was trained. Speech recognition is performed on the further speech segment using the analysis performed by the encoder-decoder transformer model. The speech recognition is accomplished in real time.

A processor-implemented method for audio analysis is disclosed comprising: obtaining a plurality of speech segments wherein the speech segments are of variable length; generating pseudo-labels for each segment within the plurality of speech segments; training an encoder-decoder transformer model comprising: processing the plurality of speech segments through a plurality of convolutional layers; and using Rotary Position Embeddings (RoPE) at each of the convolutional layers; obtaining a further speech segment; analyzing the further speech segment using the encoder-decoder transformer model which was trained; and performing speech recognition on the further speech segment using results of the analyzing of the further speech segment. Some embodiments comprise performing variable-length encoding within the transformer model. Some embodiments comprise generating audio features, based on the plurality of speech segments. In embodiments, the generating is accomplished using end-to-end machine learning. In embodiments, the filtering is based on an average log probability below a threshold value. In embodiments, the filtering removes hallucinations within the pseudo-labels.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for transformer model training for real-time automatic speech recognition.

FIG. 2 is a flow diagram for transformer model usage.

FIG. 3 is an infographic for speech recognition training.

FIG. 4 shows an example neural network.

FIG. 5 illustrates exemplary transformer model values.

FIG. 6 is a system diagram for transformer model training for real-time automatic speech recognition.

### DETAILED DESCRIPTION

Understanding spoken language is an essential skill for both humans and machine learning systems. The ability to analyze audio input and translate it into meaningful text that correctly captures the messages being expressed is invaluable in today’s rapidly expanding digital landscape. User expectations continue to evolve so that even small sub-second delays between the spoken word and the text rendered by the ML system are not only noticed, but also disdained. User demand for ML systems to not only translate spoken words correctly, regardless of how well or poorly they are expressed, but also to understand the context and meaning of the words continues to rise. While ML systems continue to improve and language datasets become larger and more diverse, processes that analyze and organize audio data more effectively and efficiently can become highly prized. Real-time automatic speech recognition (ASR) is essential for many applications, including live transcription during presentations, accessibility tools for individuals with hearing impairments, and voice command processing for conversational interfaces in smart devices and wearables. These applications often run directly on low-cost hardware, where strict resource constraints and a lack of internet connectivity introduce unique technical challenges that are not present in other ASR domains.

Techniques for transformer model training for speech recognition are disclosed. A transformer model is a type of machine learning architecture that performs the processing of sequential data efficiently, and as disclosed herein, is useful for natural language processing (NLP). It can represent words (speech) as tokens and can facilitate recognition of the relationships between different parts of input data, which enables efficient neural network processing. Collections of speech segments of various lengths are obtained from public and private sources for training a machine learning (ML) encoder-decoder transformer model. Labels that are included in the datastores of speech segments are compared to pseudo-labels that are produced by the ML model. The distance in time between the pseudo-labels and the labels supplied by the data sources are measured and used to filter out labels that are unnecessary and to improve the generation and accuracy of the pseudo-labels. The speech segments are fed into the ML model without additional packing characters. This allows the ML model to process the audio data more rapidly as it learns to discern critical bits of information without having to filter out essentially empty space. The ML model is trained by feeding the speech segments through a series of convolutional layers designed to compress the audio data and organize it so that the most essential elements are prioritized. Rotary Position Embedding (RoPE) non-linear algorithms are used in each convolutional layer in order to reveal complex patterns within the speech segments. Once the training is completed, additional speech segments of various lengths are obtained and analyzed by the ML model. The result is real-time speech recognition as the ML model analyzes the speech segments that are obtained.

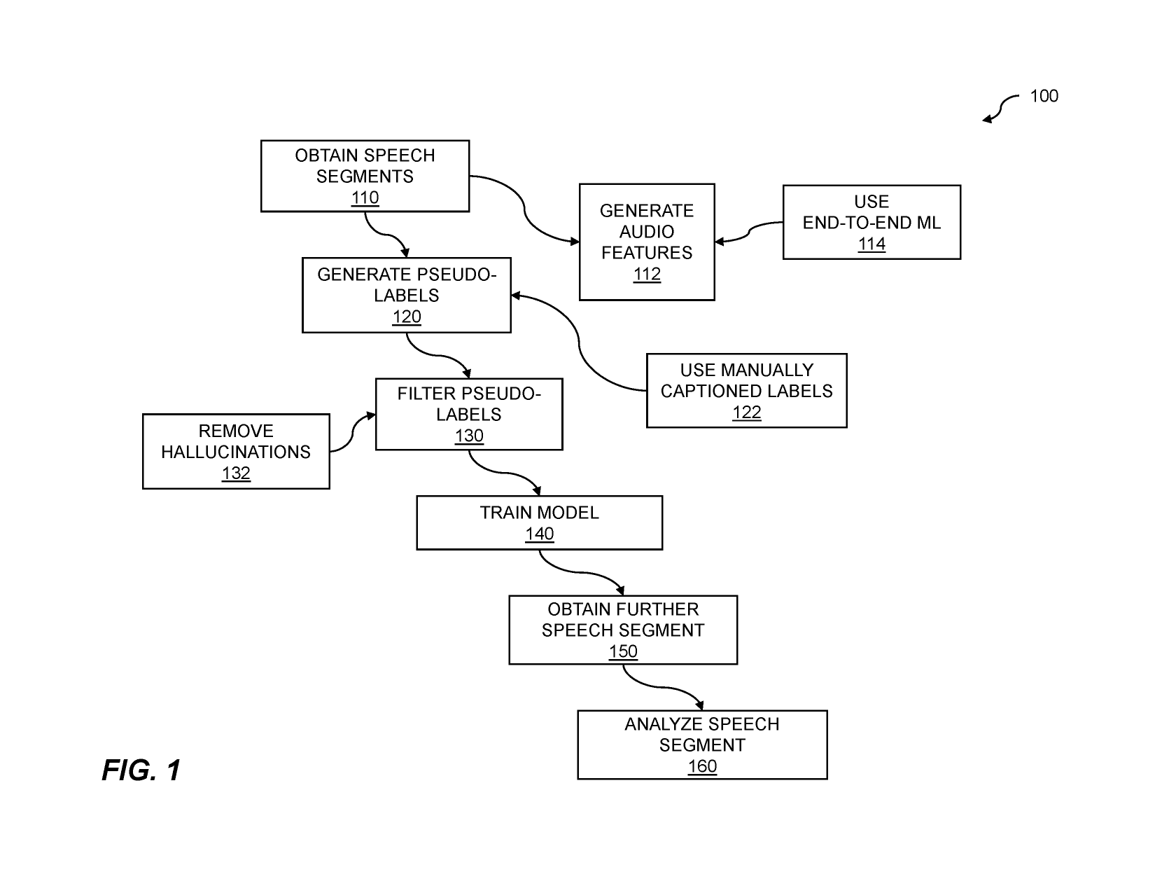

FIG. 1 is a flow diagram for transformer model training for real-time automatic speech recognition. The flow 100 includes obtaining 110 a plurality of speech segments. Speech training data can be obtained from many different sources, including open automatic speech recognition (ASR) datasets such as Common Voice, AMI, GigaSpeech, LibriSpeech, People’s Speech, and so on. Training datasets can also be developed internally using digital recordings, videos, live-feed recordings, and so on. The speech segments are of variable length. Some ASR datasets include fixed-length speech segments. However, since human speech does not always adhere to a specific time period, speech segments of variable length can be obtained and used for machine learning model training purposes.

In embodiments, the flow 100 further comprises generating 112 audio features, based on the plurality of speech segments using 114 end-to-end machine learning. End-to-end machine learning (ML) uses a single model to perform a task from raw input to final output, without any intermediate steps or manual feature extraction. For example, raw audio signals can be used as direct input for an ML model, can be analyzed by the model, and can then output the recognized speech as text. End-to-end machine learning can reduce the time and effort required for model development. However, it can require large datasets in order to train the model effectively. For speech recognition, many large training datasets are readily available. Audio features are specific characteristics of audio signals that can be used to help classify and analyze audio data. Audio features can include pitch classes, spectral or brightness, signal strength or volume, energy entropy, and so on. In embodiments, the generating of audio features is accomplished without mel spectrogram analysis. Mel spectrogram analysis is a form of hand-engineering or manipulation of audio signals to align them more closely to human auditory perception. Rather than using a mel spectrogram or other intermediate steps, the audio features can be learned and recognized directly by the machine learning model and can be used to analyze and classify further speech segments during training and production usage.

The flow 100 includes generating 120 pseudo-labels for each segment within the plurality of speech segments. A pseudo-label is a label generated by a machine learning model and assigned to a speech segment. For example, a speech segment can be labeled as “speech” or “silence.” Pseudo-labels can be used to indicate the beginning and ending of a word or specific phonemes within a word. Pseudo-labels can be used to indicate a speaker or when a speaker changes from one to another. In some cases, pseudo-labels can be used to indicate the emotional state of a speaker, and so on. In the flow 100, manually captioned labels 122 can be used to augment, enhance, or modify the labels determined for ML training. Labels on speech segments can be included as open source ASR datasets. Pseudo-labels can be generated by the ML model. Labels can also be manually generated by operators or programmers and added to the speech segments. The labels and pseudo-labels from all sources can be included in the training datasets and used to train and improve the ML model. In embodiments, the training is further based on manually captioned labels in a subset of the plurality of speech segments.

The flow 100 includes filtering 130 the pseudo-labels that were generated based on distance from captions from the speech segments. Pseudo-labels can be generated for unlabeled speech segments, and for segments that include labels from open-source datasets. The distance in time between the label included in an open-source ASR dataset and the pseudo-label generated by the ML model can be measured and used to filter out labels that are outside a selected threshold. For example, a label containing the name or language used by a speaker that appears prior to the spoken words of the speaker can be filtered out.

In embodiments, the filtering is based on an average log probability below a threshold value. Average log probability is a measurement that can be used to evaluate the performance of an ML model. It can be calculated by taking the logarithm of the ML model predicted probabilities of the true labels and then averaging the values over all instances in the dataset. The mathematical result is to penalize incorrect predictions more heavily than correct predictions. In embodiments, the filtering removes 132 hallucinations within the pseudo-labels. Machine language or artificial intelligence (AI) hallucinations are outputs from models that are incorrect or nonsensical, despite appearing plausible. For instance, an AI chatbot might report an incorrect date for a historical event or an AI generated image of a human with four arms rather than two. The average log probability filtering can help to reduce or remove hallucination outputs from the speech recognition ML model.

The flow 100 includes training 140 an encoder-decoder transformer model. The encoder-decoder transformer model can comprise a machine learning convolutional neural network (CNN), which is made up of sets of mathematical filters arranged in layers. The first layer accepts input from an outside source, applies a mathematical operation or convolution to the input value, and sends the resulting value or output on to the next filter layer. The next convolutional layer repeats the operation of applying a convolution to the input value and sending the output value on to the next filter layer. CNNs can have many convolutional layers, depending on the complexity of the data being analyzed. In embodiments, the machine learning comprises tiny machine learning. Tiny machine learning (TinyML) focuses on deploying ML models on small resource-constrained devices such as microcontrollers and Internet of Things (IoT) devices. TinyML models can run directly on a device and require extremely low amounts of power. They can receive input directly from a device and process it immediately, with low latency levels, allowing for real-time output and feedback.

The flow 100 includes obtaining a further speech segment 150. After the training of the ML model is complete, the model and associated dataset can be deployed for use in a live production environment. The production TinyML model can be included in a microcontroller embedded in IoT devices, wearables, healthcare monitoring devices, voice and speech recognition devices, and so on. The microcontroller, including the TinyML model, can be attached to a microphone or other acoustic device and can receive audio signals directly from the environment. As human speech is recorded by the microphone, segments of speech can be captured and fed into the TinyML model for analysis.

The flow 100 includes analyzing the further speech segment 160 using the encoder-decoder transformer model which was trained. As speech segments are fed into the TinyML model, the speech data can be encoded, filtered, and compared to speech data patterns included in the model. Accents, dialects, background noise, multiple voices, and so on can be sorted, classified, filtered, and compared to the extensive examples stored in the model dataset. The further speech segment then undergoes speech recognition, using the results of the analyzing of the further speech segment. In embodiments, the speech recognition is accomplished in real time. As mentioned above and throughout, the use of variable-length speech segments to train the ML model allows for rapid analysis of real-time speech obtained and analyzed by the production TinyML model. In testing, speech recognition latency can be reduced by as much as three times in comparison to other contemporary speech recognition models.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

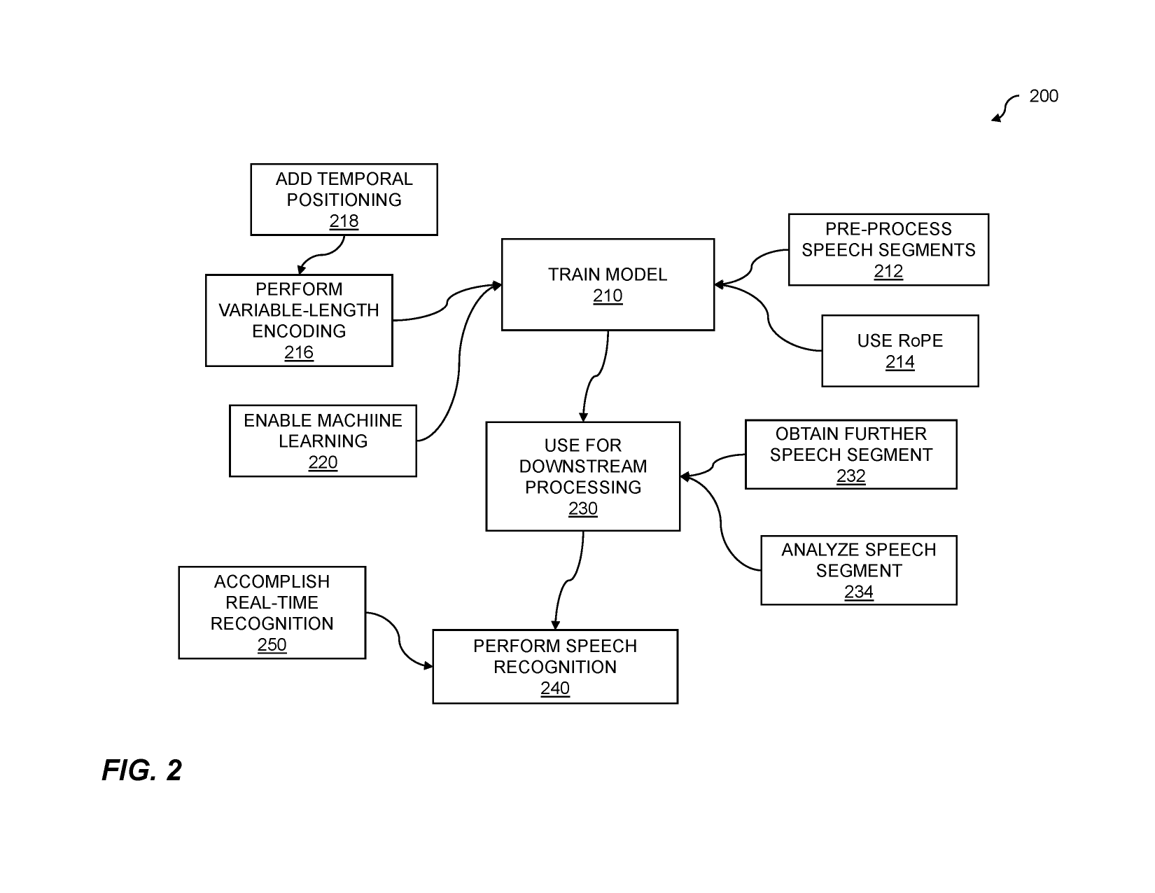

FIG. 2 is a flow diagram for transformer model usage. Model training can enable speech recognition. A plurality of speech segments of variable lengths is obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) can be used at each of the convolutional layers of the model.

The flow 200 includes training a model 210. The training a model 210 can include pre-processing the plurality of speech segments 212 through a plurality of convolutional layers. The pre-processing can be used to correct so-called noisily labeled speech segments. The pre-processing can also be used to generate training labels for unlabeled speech. The pre-processing can employ various filtering techniques, as described above. Machine learning (ML) convolutional neural networks (CNNs) are made up of sets of mathematical filters arranged in layers. The first layer accepts input from an outside source, applies a mathematical operation or convolution to the input value, and sends the resulting value or output on to the next filter layer. The next convolutional layer repeats the operation of applying a convolution to the input value and sending the output value on to the next filter layer. CNNs can have many convolutional layers, depending on the complexity of the data being analyzed. In embodiments, the machine learning comprises tiny machine learning. Tiny machine learning (TinyML) focuses on deploying ML models on small resource-constrained devices such as microcontrollers and Internet of Things (IoT) devices. TinyML models can run directly on a device and require extremely low amounts of power. They can receive input directly from a device and process it immediately, with low latency levels, allowing for real-time output and feedback.

The training a model 210 can include using Rotary Position Embeddings (RoPE) 214 at each of the convolutional layers. Rotary position embedding is a technique that can be used in natural language processing and speech segment analysis to encode positional information. Positional information can be used to encode the order of tokens, such as words, characters, phonemes, and so on, that occur in a segment of speech. The positional information can be included in the ML database entries associated with speech segments. The order of words in a sentence, sentences in a speech, phonemes in a word, and so on can be important in understanding the meaning of a word or phrase. The RoPE technique can use a rotation matrix to maintain the positional relationships between tokens even when the sequence length changes. The RoPE rotation matrix rotates the embeddings based on their sequence position, which allows the model to “understand” relative token positioning. In embodiments, the training is further based on manually captioned labels in a subset of the plurality of speech segments. As mentioned above and throughout, labels on speech segments can include open-source ASR datasets. Pseudo-labels can be generated by the ML model. Labels can also be manually generated by operators or programmers and added to the speech segments. The labels and pseudo-labels from all sources can be included in the training datasets and used to train and improve the ML model.

The flow 200 includes performing variable-length encoding 216 within the transformer model. Variable-length encoding is used in data compression so that different symbols are encoded with varying numbers of bits. The result is to reduce the size of data by assigning shorter codes to more frequently occurring symbols and longer codes to less often occurring symbols. The overall size of the data can be significantly reduced without a loss of information. In embodiments, the variable-length encoding is accomplished on the plurality of speech segments to machine learning features. As more speech segments are stored using variable length encoding, the encoding becomes more efficient, allowing more data to be stored in less overall space. In speech segment training and analysis, the use of variable length encoding can allow the input of segments of variable length. This can result in more efficient data input and analysis, allowing a more flexible ML model for speech recognition. In embodiments, the variable length of the speech segments is handled without zero padding. Zero padding is the addition of “0” characters to an end of a data record in order to normalize the record to a standard, fixed length. For example, additional time can be added to the end of a speech segment in order to make the segment exactly 30 seconds long. Zero padding can be useful in some ML models to maintain special dimensions of input data. However, zero padding can also result in additional time required to analyze data records, creating latency in speech recognition ML models and other real-time applications.

In embodiments, the flow 200 further comprises adding temporal positioning 218. The temporal positioning can be particularly useful in analyzing a further speech segment, described below. Temporal positioning can be used to capture the timing and sequence of speech data within an audio signal. ML models need to record the dependencies between different parts of each speech segment over time. The interrelationships between parts of a word, between one word and another, and between one group of words and another, can be recorded and used to understand the context and flow of the speech segment, and between one speech segment and the next. Temporal positioning can be accomplished using connectionist temporal classification (CTC), self-attention mechanisms, and so on. These techniques can be particularly useful when the length of speech within a segment varies, when the pace of speech varies, when multiple voices occur in a speech segment, and so on. The training the model 210 can enable machine learning 220. As described above and throughout, machine learning, and in particular, an encoder-decoder transformer model-based deep neural network can effectively perform power-efficient, resource-efficient, real-time speech recognition. In embodiments, the training of the encoder-decoder transformer model enables machine learning.

The flow 200 includes using the trained model for downstream processing 230. All of the sophistication and energy devoted to training the transformer model comes to fruition in efficient usage of the model downstream from the training process. After the training of the ML model is complete, the model and associated dataset can be deployed for use in a live production environment. In the flow 200, the downstream processing includes obtaining a further speech segment 232. Because the production TinyML model can be included in a microcontroller embedded in IoT devices, wearables, healthcare monitoring devices, voice and speech recognition devices, and so on, the microcontroller, including the TinyML model, can be attached to a microphone or other acoustic device and can receive audio signals directly from the environment. As human speech is recorded by the microphone, segments of speech can be captured and fed into the TinyML model for analysis. The TinyML model can enable many applications that would otherwise be inhibited by cumbersome datacenter implementations.

The flow 200 includes analyzing the further speech segment 234 using the encoder-decoder transformer model which was trained. As speech segments are fed into the TinyML model, the speech data can be encoded, filtered, and compared to speech data patterns included in the model. Accents, dialects, background noise, multiple voices, and so on can be sorted, classified, filtered, and compared to the extensive examples stored in the model dataset. The flow 200 includes performing 240 speech recognition on the further speech segment using results of the analyzing of the further speech segment. The downstream processing can thus perform speech recognition on the further speech segment. The speech recognition can be accomplished in real time 250. As mentioned above and throughout, the use of variable-length speech segments to train the ML model allows for rapid analysis of real-time speech obtained and analyzed by a production TinyML model. In testing, speech recognition latency can be reduced by as much as three times in comparison to other contemporary speech recognition models. In embodiments, the speech recognition is accomplished in real time.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

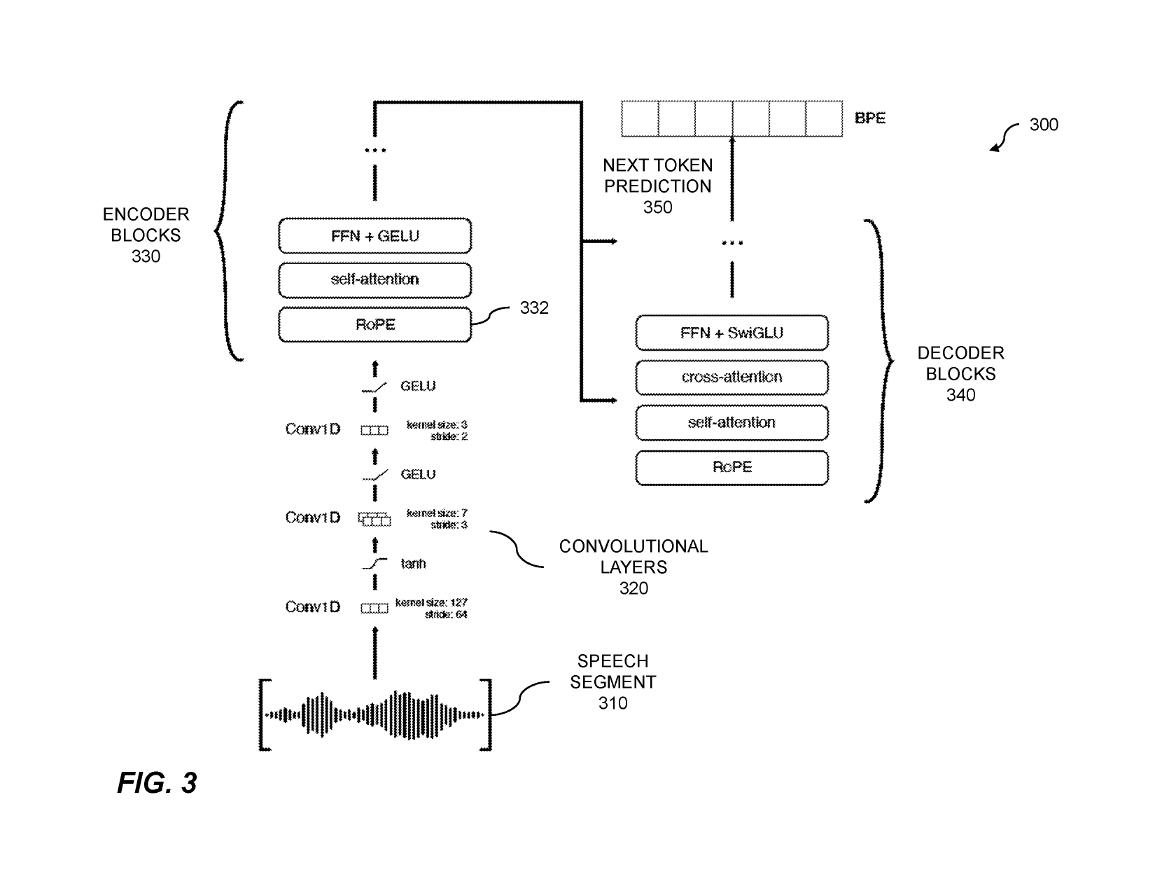

FIG. 3 is an infographic for speech recognition training. A plurality of speech segments of variable length is obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) are used at each of the convolutional layers of the model. A further speech segment is obtained and analyzed using the encoder-decoder transformer model which was trained. Speech recognition is performed on the further speech segment using the analysis performed by the encoder-decoder transformer model. The speech recognition is accomplished in real time. Audio features are generated, based on the plurality of speech segments.

The infographic 300 includes obtaining a plurality of speech segments 310. Speech training data can be obtained from many different sources, including open-source automatic speech recognition (ASR) datasets. Training datasets can also be developed internally, using digital recordings, videos, live-feed recordings, and so on. The speech segments are of variable length. Some ASR datasets include fixed-length speech segments. However, since human speech does not always adhere to a specific time period, speech segments of variable length can be obtained and used for machine learning model training purposes.

The infographic 300 includes training an encoder-decoder transformer model. An encoder-decoder transformer model is a type of machine learning neural network. Encoder-decoder models can be effective in natural language processing (NLP) tasks such as speech recognition. The encoder blocks 330 can process input from auditory sources such as a speech segment and convert the input into a sequence of numerical representations. The numerical representations, often called embeddings, capture the context and meaning of the corresponding words or tokens from the input segments. For example, each word spoken in a speech segment can be converted into numerical values representing the speaker, vocal pitch, cadence, rhythm, phonemes, word order, and so on. The decoder blocks 340 take the output from the encoder blocks and generate the desired output 350, such as a translation, summary, or recognized words in text form. Each element of the output is generated one at a time, based on previously generated elements and the encoder output for context. The output can be arranged into sequences of subword units or byte pairs that are combined to form words. This process is called Byte Pair Encoding (BPE). One advantage of BPE is that it is not language specific. Pairs of characters can be formed based on phonemes identified within one or more speech segments and used as they are encountered by the ML model.

A key component of the encoder-decoder transformer model is the use of self-attention blocks. Self-attention blocks can be used to weigh the importance of different parts of the input sequence when processing each word or token. This can allow the model to be highly effective at capturing long-range dependencies between words and phrases and understanding the context of words within sentences. FFN stands for Feed-Forward Network. An FFN is a type of ML neural network in which information flows in one direction, from input layer to output layer. An FFN can be used in combination with self-attention blocks to apply non-linear transformations, allowing the model to capture complex relationships within the speech segment data. GELU is an activation function that can be used to apply the non-linear transformations to the speech segment data. SwlGLU, used in the decoder block 340, stands for Switched Linear Unit with Gating. It is another activation function, similar to the Gaussian Error Linear Unit (GELU) activation function. SwlGLU can be used to dynamically control the contribution of input elements to the output. This can help the ML model to focus on the most relevant input elements and improve overall performance.

The infographic 300 includes processing the plurality of speech segments through a plurality 320 of convolutional layers. As mentioned above and throughout, ML convolutional neural networks can include sets of mathematical filters arranged in layers. The first layer can accept input from an outside source, such as a speech segment, apply a mathematical operation or convolution to the input value, and send the resulting value or output on to the next filter layer. In the infographic 300, the speech segment input is processed by three convolutional layers with kernel sizes of 127, 7, and 3, and corresponding strides of 64, 3, and 2 respectively. Kernels are small, rectangular matrices that slide over input data such as audio waveforms from a speech segment to extract features. They are filters that detect specific patterns or features within an audio signal. The stride refers to the step size that the filter moves across the input data. It determines how much the filter overlaps with itself as it slides over the input. The result of the three convolutional layers is to compress the input by a factor of 384 times.

Tanh and GELU are activation functions that can be used in the convolutional layers. Activation functions can be applied to the output of neurons from a convolutional layer. An activation function can introduce non-linearity into the ML model, allowing it to recognize complex patterns and relationships in data such as a speech segment. Tanh can be used to capture temporal dependencies in a speech segment. GELU can be used to improve performance and can also help to preserve important elements that can be lost in neural networks with many convolutional layers.

The training comprises using Rotary Position Embedding (RoPE) 332 at each of the convolutional layers. Rotary Position Embedding is a technique that can be used in natural language processing and speech segment analysis to encode positional information. Positional information can be used to encode the order of tokens, such as words, characters, phonemes, and so on, that occur in a segment of speech. The positional information can be included in the ML database entries associated with speech segments. The RoPE technique can use a rotation matrix to maintain the positional relationships between tokens even when the sequence length changes. In embodiments, the Rotary Position Embeddings maintain positional relationships between speech tokens. In embodiments, the positional relationships are maintained using a rotation matrix. In embodiments, the positional relationships are maintained independently from sequence length. In embodiments, the positional relationships are matched to entries within a machine learning database associated with speech segments.

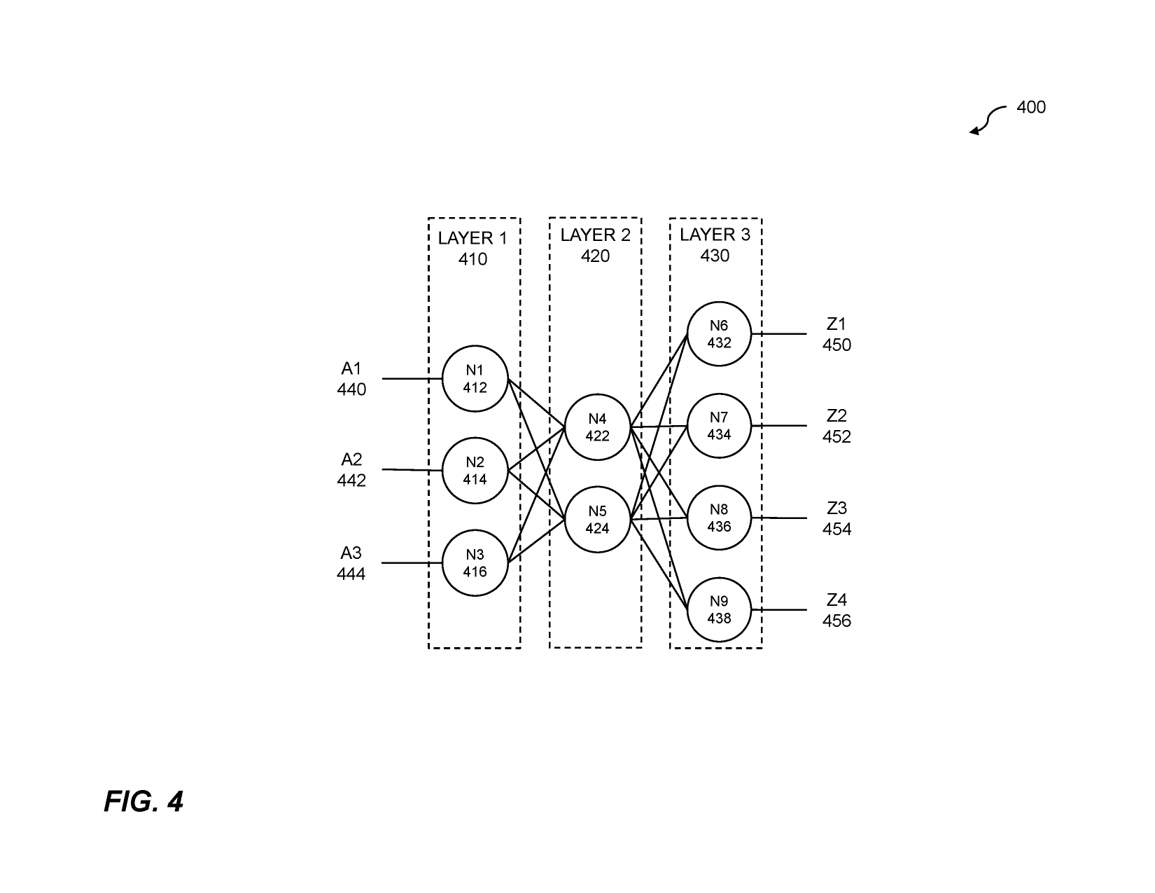

FIG. 4 shows an example neural network. The neural network can enable transformer model training for speech recognition. The network can be configured to accomplish audio and speech processing, natural language processing, text processing, image processing, and so on. The neural network can also be configured for machine learning. The neural network, such as a neural network for machine learning, can be based on various types of neural networks such as a convolutional neural network (CNN). The neural network can further include a deep neural network (DNN), a recurrent neural network (RNN), etc. The neural network comprises a plurality of layers. The neural network layers can include one or more of an input layer, an output layer, an activation layer, a bottleneck layer, a convolutional layer, and so on. The activation layer can include a nonlinear function that helps prevent the neural network from getting stuck on its maximum numeric value or its smallest numeric value. The bottleneck layer, if present, can be used for neural network training. A trained neural network can be used to detect one or more faces in a captured image, to recognize the one or more faces in the image, and the like. One or more neural networks enable a low-resolution embedded face identification sensor with machine learning. One or more images are captured by a face identification sensor, wherein the face identification sensor includes a low-resolution camera, wherein the face identification sensor includes a microcontroller and an external memory, and wherein at least two machine learning models operate simultaneously on the microcontroller. A first neural network operating on the microcontroller detects one or more faces in the image that was captured, wherein the detecting includes a first confidence score associated with each face in the one or more faces. A second neural network operating on the microcontroller can recognize the one or more faces, wherein the recognizing is based on a face ID. A second confidence score is assigned to each of the one or more faces that were recognized. The face ID is saved to the external memory, wherein the second confidence score that was assigned is below a threshold.

In the example 400, a neural network is shown. The neural network can be configured for machine learning. The neural network includes one or more layers. The layers can include input layers such as input layer 1410; intermediate or hidden layers such as layer 2420; output layers such as layer 3430; and so on. A neural network with one or a few hidden layers can include a shallow network, while a neural network with several hidden layers can include a deep network. Each layer of the neural network can include one or more nodes. Each node can include an input, a weight (not shown), a bias, etc. Layer 1 can include three nodes, node N1412, node N2414, and node N3416. The inputs A to layer 1 can include input A1440 to node N1; input A2442 to node N2; and input A3444 to node N3. A weight can be associated with each node of layer 1. The outputs of the nodes in layer 1 can be connected to one or more inputs of the nodes in layer 2. Layer 2 can include two nodes, node N4422 and node N5424. When each output of a node in a prior layer such as layer 1 is connected to input of a layer, the network layer is defined as fully connected. A weight can be associated with each node of layer 2. The outputs of the nodes in layer 2 can be connected to one or more inputs of nodes in layer 3. Layer 3 can include four nodes, node N6 432; node N7 434; node N8436; and node N9 438. A weight can be associated with each node of layer 3. In the figure, an output Z can be generated by layer 3. The outputs can include output Z1 450 from node N6; output Z2452 from node N7; output Z3 454 from node N8; and output Z4456 from node N9.

In the example neural network 400, the output of each of the nodes associated with a layer is coupled to each input of the nodes associated with a subsequent layer. The coupling of each node output of a layer to each node input of a subsequent layer comprises a fully connected (FC) layer of the neural network. While the example neural network shown includes only one hidden layer, a neural network can include other numbers of hidden layers. The hidden layers can include substantially similar layers or substantially dissimilar layers, numbers of node per layer, weights, biases, etc. The hidden layers can be fully connected layers as just described. The hidden layers can include other types of layers such as convolutional layers, where a subset of outputs is connected to a subset of inputs. The hidden layers can further include one or more of bottleneck layers, activation layers, etc.

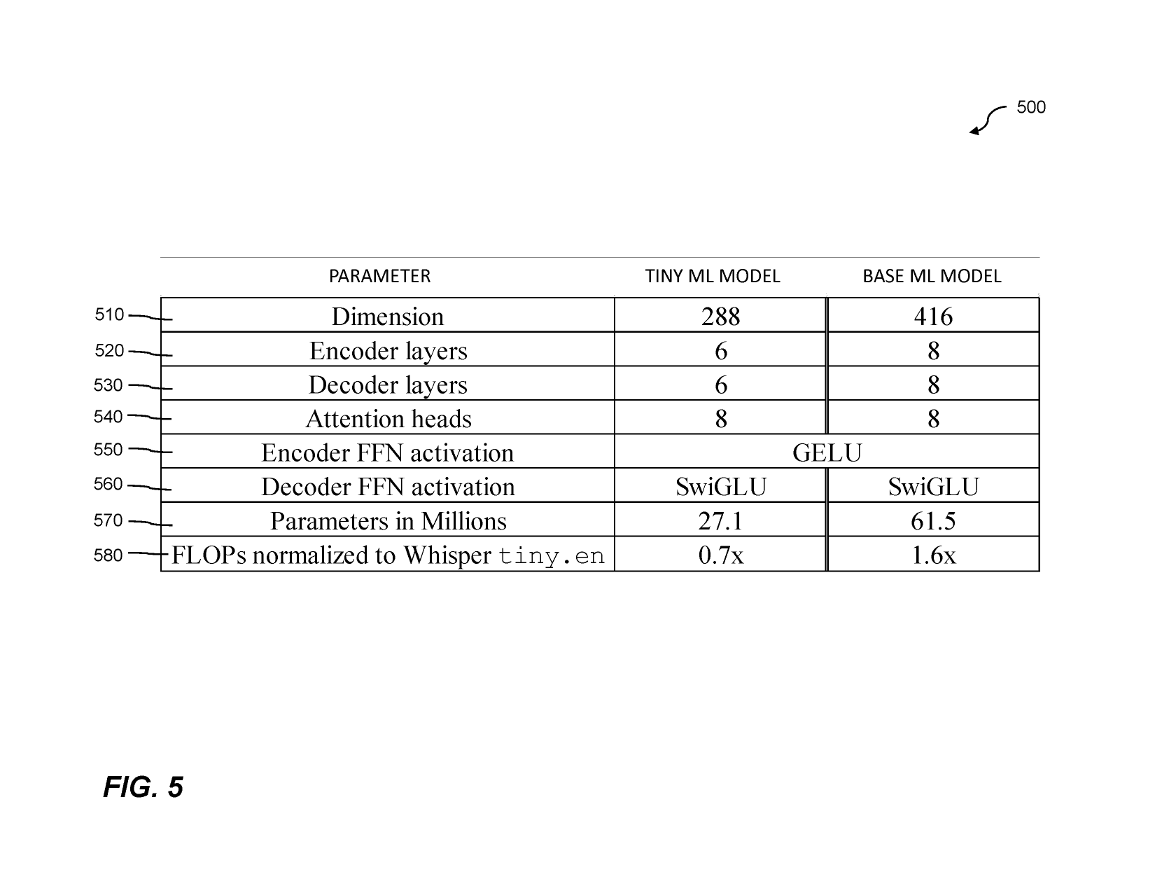

FIG. 5 illustrates exemplary transformer model values. Model values can enable transformer model training for speech recognition. A plurality of speech segments of variable length is obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) are used at each of the convolutional layers of the model.

The illustration 500 includes parameter comparisons for the TinyML model implementation versus the Base ML model implementation. The Base ML model was trained on a combination of 90K hours from open ASR datasets and over 100K hours from an internally-prepared dataset, totaling around 200K hours. Open datasets included Common Voice 16.1, the AMI corpus, GigaSpeech, LibriSpeech, the English subset of multilingual LibriSpeech, and People’s Speech. The training corpus was augmented with data collected from openly-available sources on the web. The fully trained Base ML model was used to generate the TinyML model.

The illustration 500 includes various parameters for both the TinyML and Base ML models. The first parameter is dimension 510, which refers to the number of dimensions that can be assigned to each word vector. The next two parameters list the number of encoder layers 520 and decoder layers 530 used within the two models. In both the encoder and decoder layers, the numbers of layers are 6 for the TinyML model and 8 for the Base ML model. The next parameter is attention heads 540. Attention heads are machine learning components that are used to break down words in a sentence or speech segment to allow them to be analyzed more easily. They can be used in groups to allow each word in a speech segment to be analyzed from many different angles at the same time. For example, one attention head may look at grammar, another at overall meaning, and another at how concepts within the segment relate to one another. In the illustration 500, both the TinyML and Base ML models use 8 attention heads in the analysis of speech segments.

In the illustration 500, the next parameter, encoder FFN activation 550, indicates the non-linear activation process used with input received from the speech segment. GELU stands for Gaussian Error Linear Unit and it can be used with neural networks that focus on natural language processing to improve performance. The TinyML and Base ML models both use the GELU activation function with the encoder. Both models also use the same decoder FFN activation function 560, SwiGLU. SwiGLU stands for Switched linear unit with Gating. It is similar to the GELU activation function. SwiGLU can be used to dynamically control the contribution of input elements to the output. This can help the ML model to focus on the most relevant input elements and improve overall performance. The parameters in millions 570 parameter refers to the number of values a ML model uses during the training phase. The TinyML model uses 27.1 million values, while the Base ML model uses more than twice as many, 61.5 million values. The final parameter, FLOPs normalized to Whisper tiny.en 580, is a comparison of the models to another commonly used ML model for speech recognition, Whisper tiny.en. FLOPs are floating-point operations per second and can be used to measure a computer’s computational performance. In the context of a machine language model, the number of FLOPs can indicate the processing power required to operate a particular model. The TinyML model disclosed within required 0.7 times the number of FLOPs as the Whisper tiny.en model. The Base ML required 1.6 times the number of FLOPs.

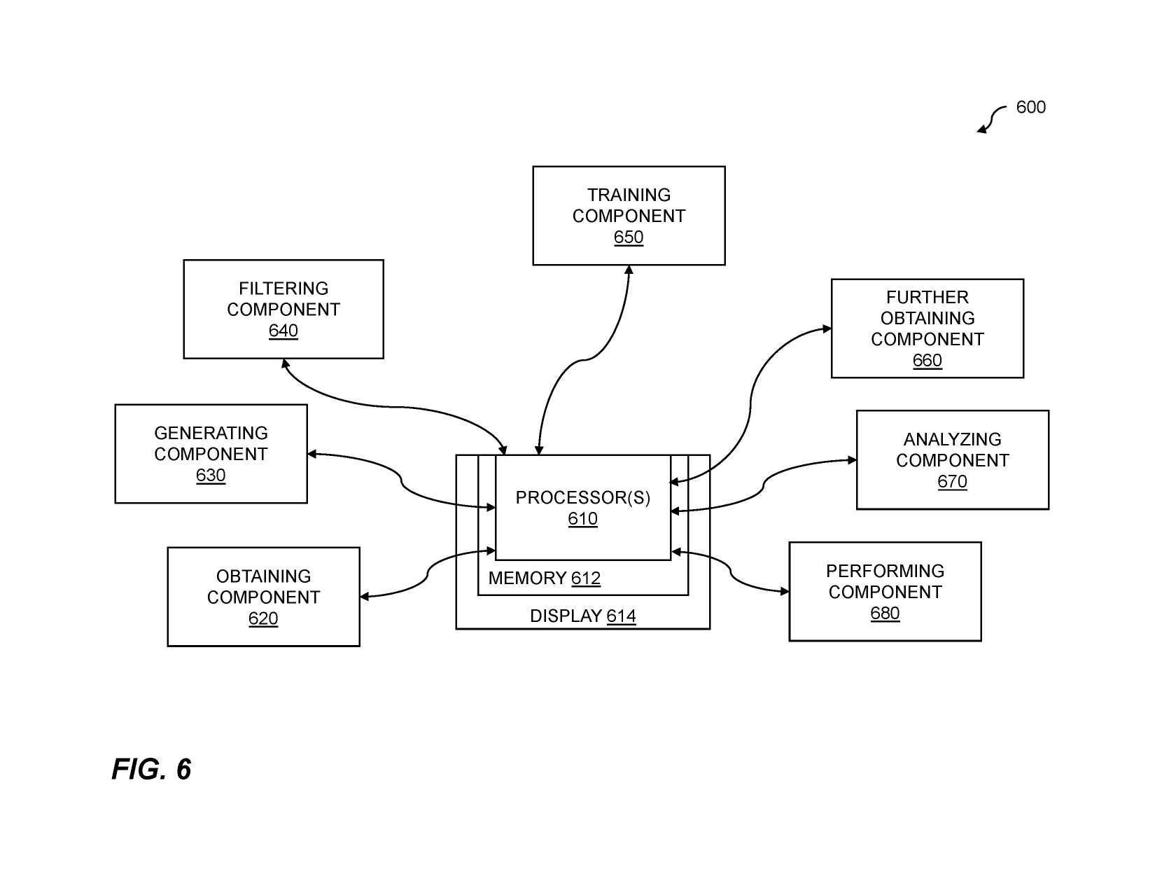

FIG. 6 is a system diagram for speech recognition training for machine learning. A plurality of speech segments of variable length is obtained. Pseudo-labels for each speech segment are generated. The pseudo-labels for each segment are filtered based on captions from the speech segments. An encoder-decoder transformer model is trained by processing the plurality of speech segments through a plurality of convolutional layers. Variable-length encoding is performed within the transformer model. The variable length of the speech segments is handled without zero padding. Rotary Position Embeddings (RoPE) are used at each of the convolutional layers of the model. A further speech segment is obtained and analyzed using the encoder-decoder transformer model which was trained. Speech recognition is performed on the further speech segment using the analysis performed by the encoder-decoder transformer model. The speech recognition is accomplished in real time. Audio features are generated, based on the plurality of speech segments.

The system 600 can include one or more processors 610 coupled to a memory 612 which stores instructions. The system 600 can include a display 614 coupled to the one or more processors 610 for displaying data, video streams, videos, intermediate steps, instructions, and so on. In embodiments, one or more processors 610 are coupled to the memory 612 where the one or more processors, when executing the instructions which are stored, are configured to: obtain a plurality of speech segments wherein the speech segments are of variable length; generate pseudo-labels for each segment within the plurality of speech segments; filter the pseudo-labels that were generated based on distance from captions from the speech segments; train an encoder-decoder transformer model configured to: process the plurality of speech segments through a plurality of convolutional layers, and use Rotary Position Embeddings (RoPE) at each of the convolutional layers; obtain a further speech segment; analyze the further speech segment using the encoder-decoder transformer model which was trained; and perform speech recognition on the further speech segment using results of the analyzing of the further speech segment.

The system 600 includes an obtaining component 620. The obtaining component 620 includes functions and instructions for obtaining a plurality of speech segments. Speech training data can be obtained from many different sources, including open automatic speech recognition (ASR) datasets. Training datasets can also be developed internally, using digital recordings, videos, live-feed recordings, and so on. The speech segments are of variable length. Some ASR datasets include fixed-length speech segments.

The system 600 includes a generating component 630. The generating component 630 includes functions and instructions for generating pseudo-labels for each segment within the plurality of speech segments. A pseudo-label is a label generated by a machine learning model and assigned to a speech segment. Pseudo-labels can be used to indicate the beginning and ending of a word or specific phonemes within a word. Pseudo-labels can be used to indicate a speaker or when a speaker changes from one to another. In some cases, pseudo-labels can be used to indicate the emotional state of a speaker, and so on.

In embodiments, the generating can include audio features, based on the plurality of speech segments using end-to-end machine learning. End-to-end machine learning (ML) uses a single model to perform a task from raw input to final output, without any intermediate steps or manual feature extraction. End-to-end machine learning can reduce the time and effort required for model development. Audio features are specific characteristics of audio signals that can be used to help classify and analyze audio data, including pitch classes, spectral or brightness, signal strength or volume, energy entropy, and so on. In embodiments, the generating of audio features is accomplished without mel spectrogram analysis. The audio features can be learned and recognized directly by the machine learning model and can be used to analyze and classify further speech segments during training and production usage.

The system 600 includes a filtering component 640. The filtering component 640 includes functions and instructions for filtering the pseudo-labels that were generated based on distance from captions from the speech segments. Pseudo-labels can be generated for unlabeled speech segments, and for segments that include labels from open-source datasets. The distance in time between the label included in an open-source ASR dataset and the pseudo-label generated by the ML model can be measured and used to filter out labels that are outside a selected threshold. In embodiments, the filtering is based on an average log probability below a threshold value. Average log probability is a measurement that can be used to evaluate the performance of an ML model. It can be calculated by taking the logarithm of the ML model predicted probabilities of the true labels and then averaging the values over all instances in the dataset. In embodiments, the filtering removes hallucinations within the pseudo-labels. Machine language or artificial intelligence (AI) hallucinations are outputs from models that are incorrect or nonsensical, despite appearing plausible. The average log probability filtering can help to reduce or remove hallucination outputs from the speech recognition ML model.

The system 600 includes a training component 650. The training component 650 includes functions and instructions for training an encoder-decoder transformer model. In embodiments, the training of the encoder-decoder transformer model comprises machine learning. The training can include processing the plurality of speech segments through a plurality of convolutional layers. In embodiments, the machine learning comprises tiny machine learning. Tiny machine learning (TinyML) focuses on deploying ML models on small resource-constrained devices such as microcontrollers and Internet of Things (IoT) devices. TinyML models can run directly on a device and can require extremely low amounts of power.

The training component can include using Rotary Position Embeddings (RoPE) at each of the convolutional layers. Rotary Position Embedding is a technique that can be used in natural language processing and speech segment analysis to encode positional information. Positional information can be used to encode the order of tokens, such as words, characters, phonemes, and so on that occur in a segment of speech. The positional information can be included in the ML database entries associated with speech segments. The RoPE technique can use a rotation matrix to maintain the positional relationships between tokens even when the sequence length changes.

In embodiments, the training is further based on manually captioned labels in a subset of the plurality of speech segments. As mentioned above and throughout, labels on speech segments can be included in open source ASR datasets. Pseudo-labels can be generated by the ML model. Labels can also be manually generated by operators or programmers and added to the speech segments. The labels and pseudo-labels from all sources can be included in the training datasets and used to train and improve the ML model.

The system 600 includes a further obtaining component 660. The further obtaining component 660 includes functions and instructions for obtaining a further speech segment. After the training of the ML model is complete, the model and associated dataset can be deployed for use in a live production environment. The production TinyML model can be included in a microcontroller embedded in IoT devices, wearables, healthcare monitoring devices, voice and speech recognition devices, and so on. The microcontroller, which includes the TinyML model, can be attached to a microphone or other acoustic device and can receive audio signals directly from the environment.

The system 600 includes an analyzing component 670. The analyzing component 670 includes functions and instructions for analyzing the further speech segment using the encoder-decoder transformer model which was trained. As speech segments are fed into the TinyML model, the speech data can be encoded, filtered, and compared to speech data patterns included in the model. Accents, dialects, background noise, multiple voices, and so on can be sorted, classified, filtered, and compared to the extensive examples stored in the model dataset.

The system 600 includes a performing component 680. The performing component 680 includes functions and instructions for performing speech recognition on the further speech segment using results of the analyzing of the further speech segment. In embodiments, the speech recognition is accomplished in real time. As mentioned above and throughout, the use of variable-length speech segments to train the ML model allows for rapid analysis of real-time speech obtained and analyzed by the production TinyML model.

The system 600 can include a computer program product embodied in a non-transitory computer readable medium for audio analysis, the computer program product comprising code which causes one or more processors to perform operations of: obtaining a plurality of speech segments wherein the speech segments are of variable length; generating pseudo-labels for each segment within the plurality of speech segments; filtering the pseudo-labels that were generated based on distance from captions from the speech segments; training an encoder-decoder transformer model comprising: processing the plurality of speech segments through a plurality of convolutional layers; and using Rotary Position Embeddings (RoPE) at each of the convolutional layers; obtaining a further speech segment; analyzing the further speech segment using the encoder-decoder transformer model which was trained; and performing speech recognition on the further speech segment using results of the analyzing of the further speech segment.

The system 600 can include a computer program product embodied in a non-transitory computer readable medium for audio analysis, the computer program product comprising code which causes one or more processors to generate semiconductor logic for: obtaining a plurality of speech segments wherein the speech segments are of variable length; generating pseudo-labels for each segment within the plurality of speech segments; filtering the pseudo-labels that were generated based on distance from captions from the speech segments; training an encoder-decoder transformer model comprising: processing the plurality of speech segments through a plurality of convolutional layers; and using Rotary Position Embeddings (RoPE) at each of the convolutional layers; obtaining a further speech segment; analyzing the further speech segment using the encoder-decoder transformer model which was trained; and performing speech recognition on the further speech segment using results of the analyzing of the further speech segment

Each of the above methods may be executed on one or more processors on one or more computer systems. Embodiments may include various forms of distributed computing, client/server computing, and cloud-based computing. Further, it will be understood that the depicted steps or boxes contained in this disclosure’s flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for audio analysis comprising:
obtaining a plurality of speech segments wherein the speech segments are of variable length;
generating pseudo-labels for each segment within the plurality of speech segments;
filtering the pseudo-labels that were generated based on distance from captions from the speech segments;
training an encoder-decoder transformer model comprising:
processing the plurality of speech segments through a plurality of convolutional layers; and
using Rotary Position Embeddings (RoPE) at each of the convolutional layers;
obtaining a further speech segment;
analyzing the further speech segment using the encoder-decoder transformer model which was trained; and
performing speech recognition on the further speech segment using results of the analyzing of the further speech segment.

2. The method of claim 1 wherein the training is further based on manually captioned labels in a subset of the plurality of speech segments.

3. The method of claim 1 further comprising performing variable-length encoding within the transformer model.

4. The method of claim 3 wherein the variable-length encoding is accomplished on the plurality of speech segments to machine learning features.

5. The method of claim 1 wherein the variable length of the speech segments is handled without zero padding.

6. The method of claim 1 further comprising generating audio features, based on the plurality of speech segments.

7. The method of claim 6 wherein the generating is accomplished using end-to-end machine learning.

8. The method of claim 7 wherein the generating of audio features is accomplished without mel spectrogram analysis.

9. The method of claim 1 wherein the filtering is based on an average log probability below a threshold value.

10. The method of claim 9 wherein the filtering removes hallucinations within the pseudo-labels.

11. The method of claim 1 wherein the training of the encoder-decoder transformer model enables machine learning.

12. The method of claim 11 wherein the machine learning comprises tiny machine learning.

13. The method of claim 1 wherein the speech recognition is accomplished in real time.

14. The method of claim 1 further comprising adding temporal positioning for the further speech segment.

15. The method of claim 1 wherein the Rotary Position Embeddings maintain positional relationships between speech tokens.

16. The method of claim 15 wherein the positional relationships are maintained using a rotation matrix.

17. The method of claim 15 wherein the positional relationships are maintained independently from sequence length.

18. The method of claim 15, wherein the positional relationships are matched to entries within a machine learning database associated with speech segments.

19. A computer program product embodied in a non-transitory computer readable medium for audio analysis, the computer program product comprising code which causes one or more processors to perform operations of:
obtaining a plurality of speech segments wherein the speech segments are of variable length;
generating pseudo-labels for each segment within the plurality of speech segments;
filtering the pseudo-labels that were generated based on distance from captions from the speech segments;
training an encoder-decoder transformer model comprising:
processing the plurality of speech segments through a plurality of convolutional layers; and
using Rotary Position Embeddings (RoPE) at each of the convolutional layers;
obtaining a further speech segment;
analyzing the further speech segment using the encoder-decoder transformer model which was trained; and
performing speech recognition on the further speech segment using results of the analyzing of the further speech segment.

20. A computer system for audio analysis comprising:
a memory which stores instructions;
one or more processors coupled to the memory, wherein the one or more processors, when executing the instructions which are stored, are configured to:
obtain a plurality of speech segments wherein the speech segments are of variable length;
generate pseudo-labels for each segment within the plurality of speech segments;
filter the pseudo-labels that were generated based on distance from captions from the speech segments;
train an encoder-decoder transformer model configured to:
process the plurality of speech segments through a plurality of convolutional layers; and
use Rotary Position Embeddings (RoPE) at each of the convolutional layers;
obtain a further speech segment;
analyze the further speech segment using the encoder-decoder transformer model which was trained; and
perform speech recognition on the further speech segment using results of analyzing of the further speech segment.
